(19) United States
(12) Patent Application Publication
(10) Pub. No.: US 2014/0375791 A1
(43) Pub. Date: Dec. 25, 2014

(54) TELEVISION CONTROL METHOD AND ASSOCIATED TELEVISION

(71) Applicant: MStar Semiconductor, Inc., Hsinchu Hsien (TW)

(72) Inventor: Hung-Chi Huang, Hsien (TW)

(21) Appl. No.: 14/307,718

(22) Filed: Jun. 18, 2014

(30) Foreign Application Priority Data
Jun. 20, 2013 (TW) 102122001

(51) Int. Cl. H04N 5/63; H04N 5/44; G06K 9/00

(52) U.S. Cl. CPC H04N 5/63; G06K 9/00308; H04N 5/4403; H04N 2005/4444
USPC 348/78; 348/730

(57) ABSTRACT

When a user watching television does not send a command for operating the television within a predetermined time period, the television detects whether the user enters a sleep status or has left a detectable range of the television. The detection result is utilized as a reference for rendering the television to enter a hibernation mode to prevent unnecessary power consumption of the television.

This application claims the benefit of Taiwan application Serial No. 102122001, filed Jun. 20, 2013, the subject matter of which is incorporated herein by reference.

### BACKGROUND OF THE INVENTION

1. Field of the Invention

The invention relates in general to a television control method and a television, and more particularly, to a television control method that determines whether to render a television to enter a hibernation mode according to whether a user of the television is in a sleep status, and a television applying the television control method.

2. Description of the Related Art

People often fall asleep accidentally while watching television in household; with however the television continuing playing television programs to result in huge power waste. A main reason of the above situation is that, viewers often lack self-restraint to immediately turn off the television and go to bed while they are already tired. In addition, conventional televisions do not support the function of deciding whether to turn themselves off according to conditions of the viewers, in a way that the power consumption during a period from the viewers having fallen asleep to waking up may add up to considerable amounts. Such waste contradicts the modern trend of carbon reduction and environmental protection awareness.

### SUMMARY OF THE INVENTION

To solve of the above issue of huge power waste caused by a still operating television after a viewer of the television falls asleep, the present invention discloses a television control method and a television applying the method, which are capable of appropriately and effectively preventing power waste of the television when a user falls asleep and when the television is left idle.

According to an embodiment of the present invention, a television control method includes: when a television is in a turned on status and a user interface device of the television is not operated within a predetermined time period, detecting a biological recognition status of a user within a detectable range of the television; and rendering the television to enter a sleep mode when the user is in a sleep status.

According to an embodiment of the present invention, a television control method includes: when a television is in a turned on status and a user interface device of the television is not operated within a predetermined time period, detecting whether a user is present within a detectable range of the television; and rendering the television to enter a hibernation mode when no user is present within the detectable range of the television.

According to an embodiment of the present invention, a television includes a user interface device, a user status detecting module, and a power control module. The user status detecting module detects a biological recognition status of a user within a detectable range of the television when the television is in a turned on status and the user interface device is not operated within a predetermined time period. The power control module renders the television to enter a hibernation mode when the user status detecting module determines that the user is in a sleep status.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. is a function block diagram of a television according to an embodiment of the present invention; and

FIG. 2 and FIG. 3 are flowcharts of a television control method according to an embodiment of the present invention.

### DETAILED DESCRIPTION OF THE INVENTION

FIG. 1 shows a functional block diagram of a television 100 according to an embodiment of the present invention. As shown in FIG. 1, the television 100 includes at least a user interface device 110, a user status detecting module 120, a power control module 130 and a display module 140.

The user interface device 110 receives a command sent from a user, e.g., a remote control command that the user sends via a television remote controller.

When the television 100 is in a power-on status and the user interface device 110 is not operated for a predetermined time period, the user status detecting module 120 detects a biological recognition status of a viewer within a detectable range of the television. In an embodiment of the present invention, the biological recognition status may be utilized as an objective reference for determining whether a user of the television 100 enters a sleep status. For example, the biological recognition status may be a body temperature or a heartbeat of the user, and/or whether eyes of the user in a captured image of the user are closed, i.e., an eyelid open/close status of the user in the captured image.

The power control module 130 determines whether to render the television 100 to enter a hibernation mode according to a status of the user of the television 100. For example, the hibernation mode is a power-saving mode or a power-off mode of the television 100. The display module 140 displays a program of the channel played by the television 100 according to the channel that the user sets via the user interface device 110. Alternatively, the display module 140 displays setting options of the television 100 provided to the user.

In an embodiment of the present invention, the television 100 may further include a preference setting module 150. According to a command that the user sends via the user interface device 110, the preference setting module 150 sets a condition for rendering the television 100 to enter a hibernation mode to the preference setting module 150. For example, the preference setting module 150 may provide two different status settings for determining whether to enter a hibernation mode for the user to select from—whether the user has entered a sleep status and whether the user has left a detectable range for a predetermined time period. According to a command that the user sends via the user interface device 110, the preference setting module 150 then prompts the power control module 130 to utilize one of the two status settings to determine whether to render the television 100 to enter a hibernation mode. Further, according to a command that the user sends via the user interface device 110, the preference setting module 150 may set the user status detecting module 120 to detect the type of the above biological recognition status or set the method for detecting whether the user has left the detectable range of the television 100.

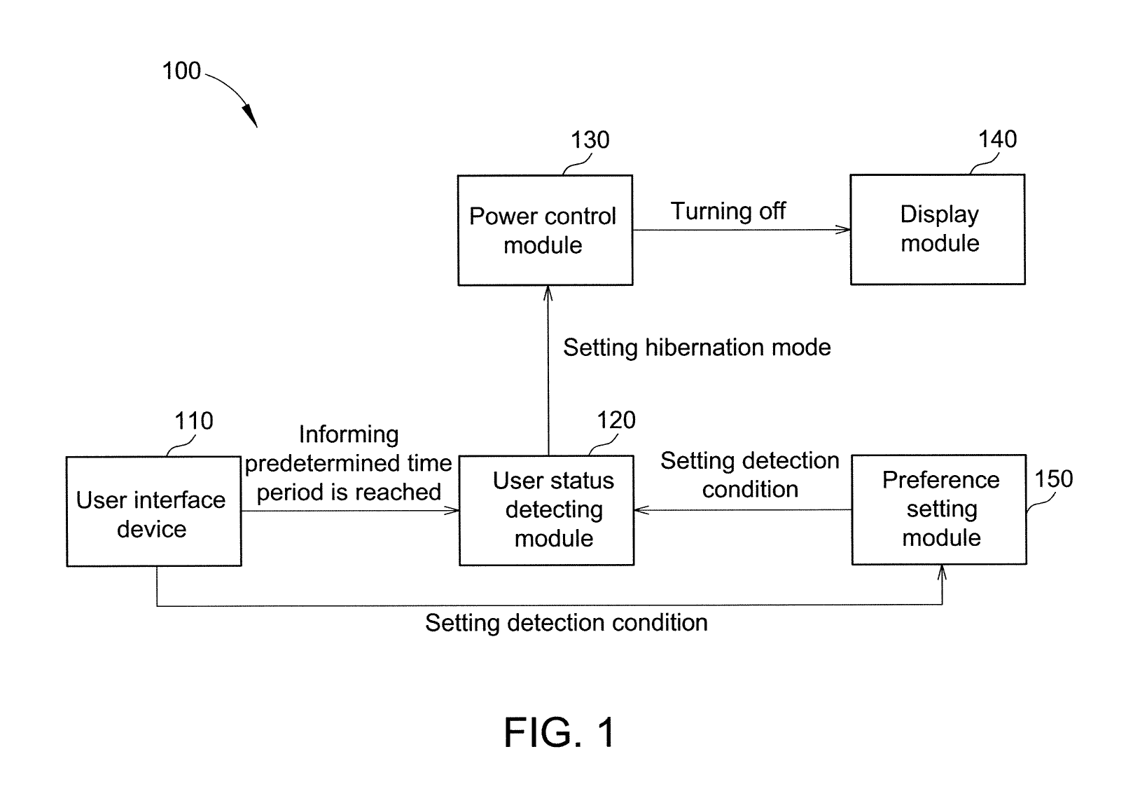

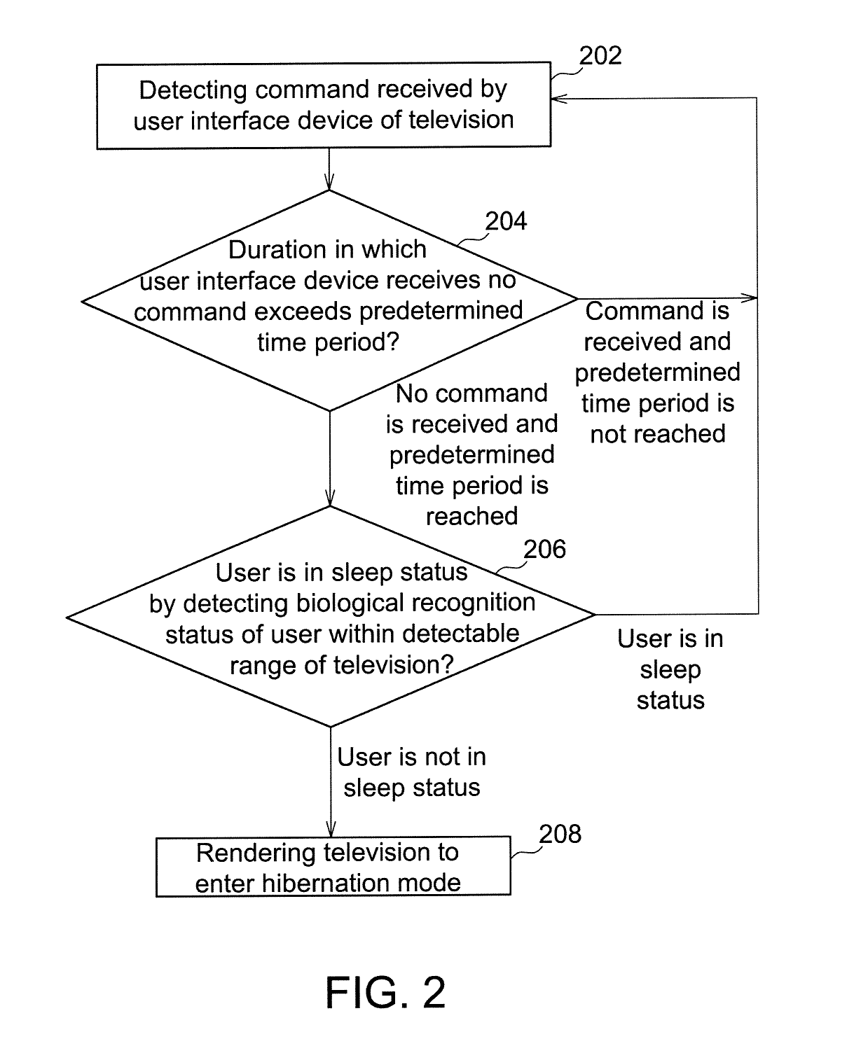

FIG. 2 shows a flowchart of a television control method according to an embodiment of the present invention. Referring to FIG. 2, the method includes the following steps.

In step 202, a command received by the user interface device 110 of the television 100 is detected.

In step 204, it is determined whether a duration in which no command from the user interface device 110 is received exceeds a predetermined time period. When the duration in which no command from the user interface device 110 is received exceeds the predetermined time period, step 206 is performed. Else, when the user interface device 110 receives a command before the duration reaches the predetermined time period, step 202 is again performed.

In step 206, a biological recognition status of a user within a detectable range of the television 100 is detected to confirm whether the user is in a sleep status. Step 208 is performed when the user is in a sleep status, or else step 202 is performed.

In step 208, the television 100 is rendered to enter a hibernation mode.

Details of the steps in FIG. 2 are described below.

In step 202, it is assumed that the user of the television 100 has turned on the television 100 via the user interface device 110 (i.e., the television 100 is in a power-on status), the user interface device 110 continues detecting a command that the user enters to the user interface device 110.

In step 204, when the user interface device 110 confirms that no command is received within a predetermined duration, the television 100 determines that the user may have entered a sleep status. Thus, in step 206, the user status detecting module 120 detects a biological recognition status of any user existing within a detectable range of the television 100 to confirm whether the user has already entered a sleep status. The biological recognition status includes the above objective references for determining whether the user of the television 100 has entered a sleep status. A sleep status may refer to falling asleep or further include a sleepy status. The predetermined duration may be a predetermined time period, or may be pre-set by the user via the user interface device 110, e.g., 10 minutes.

When the user status detecting module 120 confirms that the user has entered the sleep status in step 206, in step 208, the power control module 130 renders the television 100 to enter a hibernation mode. As such, the power consumption of the display module 140 is significantly reduced, or the television 100 can be completely turned off to reduce the power consumption to zero for achieving power-saving effects. When the user activates the television 100 after waking up, the television re-starts from step 202 to start timing the above duration.

Further, in step 204, when the user interface device 100 receives a command before the duration is reached, step 202 is repeated to reset the duration to zero, and the duration is again timed from afresh.

In step 206, when the user status detecting module 120 confirms that the user has not entered the sleep status, step 202 is again performed to have the user status detecting module 120 to again start timing the above duration.

The method disclosed in FIG. 2 determines whether to render the television 100 to enter a hibernation mode according to whether the user enters a sleep status. In another embodiment of the present invention, whether to render the television 100 to enter a hibernation mode is determined according to whether a user is located within a detectable range of the television 100. That is, whether a user has left the television 100 for an excessive period is utilized to determine whether to render the television 100 to enter a hibernation mode, so as to prevent unnecessary power consumption due to the user having left the television 100 for an excessive period.

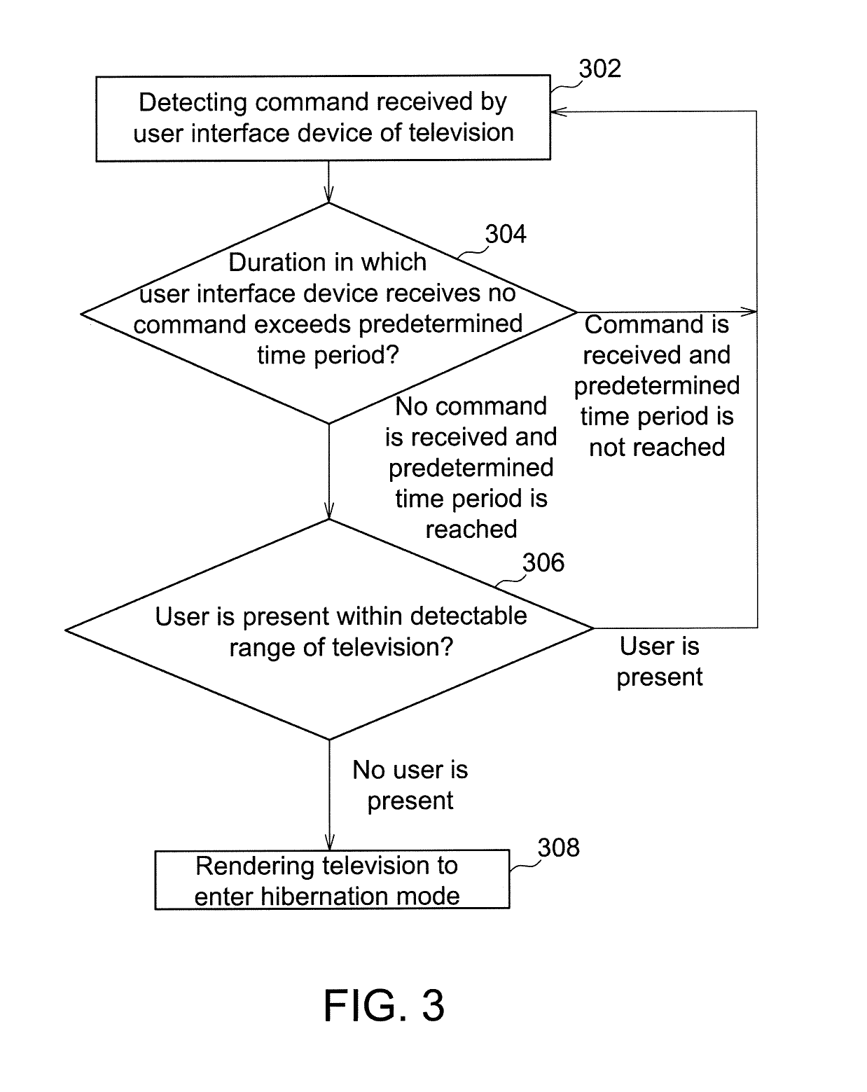

FIG. 3 shows a flowchart of a television control method according to an embodiment of the present invention. Referring to FIG. 3, the method includes the following steps.

In step 302, a command received by the user interface device 110 of the television 100 is detected.

In step 304, it is determined whether a duration in which no command from the user interface device 110 is received exceeds a predetermined time period. When the duration in which no command from the user interface device 110 is received exceeds the predetermined time period, step 306 is performed. Else, when the user interface device 110 receives a command before the duration reaches the predetermined time period, step 302 is again performed.

In step 306, it is detected whether a user is present within a detectable range of the television 100. Step 308 is performed when no user is present, or else step 302 is performed.

In step 308, the television 100 is rendered to enter a hibernation mode.

A main difference between the methods in FIG. 2 and FIG. 3 is that references for determining whether to render the television 100 to enter a hibernation mode in step 206 and step 306 are different, whereas other steps and associated principles are the same. For example, step 202 is the same as step 302, step 204 is the same as step 304, and step 208 is the same as 308.

In step 306, the user status detecting module 120 determines whether a user is present within the detectable range of the television 100. In one embodiment, an image within the detectable range in front of the display module 140 is captured by the television to accordingly determine whether a user is present within the detectable range. When the user status detecting module 120 determines that no user is present within the detectable range of the television 100, step 308 is performed to have the power control module 130 to control the television 100 to enter a hibernation mode. Conversely, when the user status detecting module 120 determines that at least one user is present within the detectable range of the television 100, step 302 is again performed to have the user interface device 110 to again start timing the duration in which no command is received.

Similarly, the method disclosed in FIG. 3 ensures that the television 100 enters the hibernation mode after the user leaves the detectable range of the television 100 for a predetermined duration, thereby efficiently reducing the power consumption of the television 100 in the event that the user of the television 100 forgets to turn off the television 100 when leaving the television 100.

As previously described, the user may set the preference setting module 150 by sending out a command via the user interface device 110 to select the television control method in FIG. 2 or FIG. 3.

It should be noted that, reasonable combinations of the steps in FIG. 2 and FIG. 3 and/or embodiments derived from limitations described in the disclosure are to be regarded as embodiments of the present invention.

A television control method and a television applying the television control method are disclosed by the present invention as above. With the television control method and the television, when a user watching television does not send a command for operating the television within a predetermined time period, the television detects whether the user enters a sleep status or has left a detectable range of the television. The detection result is utilized as a reference for rendering the television to enter a hibernation mode to prevent unnecessary power consumption of the television.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A television control method, comprising:
when a television is in a power-on status and a user interface device of the television is not operated within a predetermined time period, detecting a biological recognition status of a user within a detectable range of the television; and
when the user is in a sleep status, rendering the television to enter a hibernation mode.

2. The method according to claim 1, further comprising:
before detecting the biological recognition status of the user within the detectable range of the television, detecting whether a user is present within the detectable range of the television.

3. The method according to claim 1, wherein the biological recognition status comprises a body temperature, a heartbeat, and/or an eyelid open/close status of the user in a captured image.

4. The method according to claim 1, wherein the step of detecting the biological recognition status of the user within the detectable range of the television comprises:
capturing an image within the detectable range; and
detecting an eyelid open/close status of the user in the image to determine whether the user is in the sleep status.

5. The method according to claim 1, wherein the hibernation mode is a power-saving mode or a power-off mode.

6. A television control method, comprising:
when a television is in a power-on status and a user interface device of the television is not operated within a predetermined time period, detecting whether a user is present within a detectable range of the television; and
when no user is present within the detectable range of the television, rendering the television to enter a hibernation mode.

7. The method according to claim 6, wherein the hibernation mode is a power-saving mode or a power-off mode.

8. A television, comprising:
a user interface device;
a user status detecting module, configured to detect a biological recognition status of a user within a detectable range of the television when a television is in a power-on status and a user interface device of the television is not operated within a predetermined time period; and
a power control module, configured to render the television to enter a hibernation mode when the user status detecting module determines that the user is in a sleep status.

9. The television according to claim 8, wherein the user status detecting module is further configured to detect whether a user is present within the detectable range of the television before detecting the biological recognition status of the user within the detectable range of the television.

10. The television according to claim 8, wherein the biological recognition status of the user comprises a body temperature, a heartbeat, and/or an eyelid open/close status of the user in a captured image.

11. The television according to claim 8, wherein the user status detecting module is further configured to capture an image within the detectable range, and to detect an eyelid open/close status of the user in the image to determine whether the user is in the sleep status.

12. The television according to claim 8, wherein the user interface device is further configured to set a length of the predetermined time period and/or set a type of the biological recognition status detected by the user status detecting module according to a user command received.

13. The television according to claim 8, wherein the hibernation mode is a power-saving mode or a power-off mode.
